(19) United States
(12) Patent Application Publication
(10) Pub. No.: US 2026/0127754 A1
(43) Pub. Date: May 7, 2026

(54) SIMULTANEOUS NAVIGATION AND RECONSTRUCTION VIA MONOCULAR DEPTH ESTIMATION

(71) Applicant: The Trustees of Princeton University, Princeton, NJ (US)

(72) Inventors: Nathaniel Simon, Princeton, NJ (US); Anirudha Majumdar, Hillsborough, NJ (US)

(73) Assignee: The Trustees of Princeton University, Princeton, NJ (US)

(21) Appl. No.: 18/953,371

(22) Filed: Nov. 20, 2024

Related U.S. Application Data
(60) Provisional application No. 63/600,866, filed on Nov. 20, 2023.

(51) Int. Cl. G06T 7/55; G01C 21/00; G01C 21/20; G06T 3/00; G06T 7/70

(52) U.S. Cl. CPC G06T 7/55; G01C 21/20; G01C 21/3837; G01C 21/3859; G06T 3/00; G06T 7/70; G06T 2207/10032; G06T 2207/20081; G06T 2207/20084

(57) ABSTRACT

Provided are systems and techniques for automated navigation of vehicles, such as drones. The systems generally include processing unit(s) that, collectively, perform several steps. Such steps include generating metric depth estimates, using a pre-trained model, for each pixel in received image(s) from a monocular camera, or transformed image(s) based on the received image(s). Such steps may also include generating a pose estimate from visual odometry, then generating a truncated signed distance function representation of an environment based on the absolute depth estimates and the pose estimate. The steps may include creating and/or updating a local map based on the truncated signed distance function representation. The steps may include plan a collision-free route towards a goal based on the local map. This may include using motion primitives, which may be generated in a single offline step and stored in a trajectory library.

### CROSS-REFERENCE TO RELATED APPLICATIONS

The present application claims priority to U.S. Provisional Patent Application No. 63/600,866, filed Nov. 20, 2023, the contents of which are incorporated by reference herein in its entirety.

### STATEMENT REGARDING FEDERALLY SPONSORED RESEARCH OR DEVELOPMENT

This invention was made with government support under Grant Nos. DGE-2039656 and 2044149 awarded by the National Science Foundation, and Grant No. N00014-23-1-2148 awarded by the Office of Naval Research (ONR). The government has certain rights in the invention.

### TECHNICAL FIELD

The present disclosure relates to techniques for controlling drones, and specifically to techniques for controlling monocular robots or vehicles, such as, e.g., Micro Aerial Vehicle (MAV) platforms (≤100 g)

### BACKGROUND

A major challenge in deploying the smallest of Micro Aerial Vehicle (MAV) platforms (≤100 g) is their inability to carry sensors that provide high-resolution metric depth information (e.g., LiDAR or stereo cameras). Current systems rely on end-to-end learning or heuristic approaches that directly map images to control inputs, and struggle to fly fast in unknown environments.

### BRIEF SUMMARY

In various aspects, a system for navigation may be provided. The system may include one or more processing units configured to, collectively, perform various tasks. Some or all of the processing unit(s) may be disposed on a vehicle, such as a drone, which may be, e.g., a flying drone, such as a micro aerial vehicle (MAV). The vehicle may be some other vehicle besides a MAV, including, e.g., cars, on-ground delivery drones, etc.

The tasks may include receiving one or more images from a monocular camera. The tasks may include generating metric depth estimates for each pixel in the received image(s) or transformed image(s) based on the received image(s), using a pre-trained model. The tasks may include generating a pose estimate from visual odometry. The tasks may include generating a truncated signed distance function representation of an environment based on the absolute depth estimates and the pose estimate. The tasks may include generating or updating a local map based on the truncated signed distance function representation.

The received image(s) from the monocular camera may include a first distorted image, and the tasks performed by the processing unit(s) may include extracting multiple depth images from the first distorted image using a virtual camera rotation scheme.

The tasks may include generating the transformed image(s) such that transformed image(s) appear to have been taken with a same camera used to train the pre-trained model.

The tasks may include discretizing the environment into blocks. The tasks may include storing blocks containing surfaces in a hashmap. The tasks may include planning a collision-free route towards a goal based on the local map. Planning the collision-free route may include using motion primitives. The motion primitives may be generated in a single offline step and stored in a trajectory library. The motion primitives may be defined to have a yaw rate that is zero at the beginning and end of each motion primitive. A library of motion primitives may be generated by varying a maximum yaw rate.

Planning the collision-free route may include utilizing A*, Probabilistic Roadmaps (PRM), rapidly-exploring random tree (RRT), RRT*, or Trajectory Hybrid Optimal Frenet.

In various aspects, a method for navigation may be provided. The method may include receiving one or more images from a monocular camera. The method may include generating metric depth estimates for each pixel in the received image(s) or transformed image(s) that are based on the received image(s), using a pre-trained model. The method may include generating a pose estimate from visual odometry. The method may include generating a truncated signed distance function representation of an environment based on the absolute depth estimates and the pose estimate. The method may include generating or updating a local map based on the truncated signed distance function representation.

The method may include repeatedly performing the receiving, generating, and updating steps as a vehicle including the monocular camera moves within the environment (e.g., at forwards velocities of at least 0.5 m/s).

### BRIEF DESCRIPTION OF FIGURES

FIG. 1 is a schematic illustration of a system.

FIG. 2 is a flowchart of a method.

FIG. 3 is a flowchart of a method for planning a route.

FIG. 4 is a flowchart of a steps performed by an embodiment of a vehicle.

FIG. 5 is a schematic illustration of a method.

FIG. 6 is an illustration of point cloud distances for Crazyflie ZoeDepth and Azure Kinect images.

FIGS. 7-10 are plots of the trajectories of all 15 trials in 5 unique environments, the goal positions (circles), and the crash locations (stars), including moving around a first corner (FIG. 7), moving around a second corner (FIG. 8), and moving through three different hallway paths for MonoNav (FIG. 9) and NoMaD (FIG. 10).

FIG. 11 is an illustration of a captured field of view (FOV) versus a transformed FOV.

FIG. 12 is an illustration showing the FOV of two sub-images as part of a virtual rotation scheme.

FIG. 13 is a graph showing performance improvements of a MAV using a virtual rotation scheme as compared to a baseline NoMaD performance and the MAV without use of the virtual rotation scheme.

### DETAILED DESCRIPTION

Disclosed herein are simultaneous navigation and reconstruction via monocular depth estimation. The approach disclosed herein employs, inter alia, a monocular camera, optical odometry, and offboard computation to allow for the creation of metrically accurate maps to leverage the powerful path planning and navigation approaches employed by larger state-of-the-art robotic systems to achieve robust autonomy in unknown environments. More particularly, the disclosed approach, MonoNav, comprises a fast 3D reconstruction and navigation stack for MAVs that leverages recent advances in depth prediction neural networks to enable metrically accurate 3D scene reconstruction from a stream of monocular images and poses.

The disclosed MonoNav system and method uses off-the-shelf pre-trained monocular depth estimation and fusion techniques to construct a map, then searches over motion primitives to plan a collision-free trajectory to the goal. In extensive hardware experiments, it was demonstrated how MonoNav enables the Crazyflie (a 37 g MAV) to navigate fast (0.5 m/s) in cluttered indoor environments. MonoNav was evaluated against a state-of-the-art end-to-end approach, and it was found that the collision rate in navigation is significantly reduced (by a factor of 4; this increased safety comes at the cost of conservatism in terms of a 22% reduction in goal completion).

To provide various improvements over conventional techniques, a system and method for navigation are provided that include simultaneous (or near-simultaneous) reconstruction and planning processes.

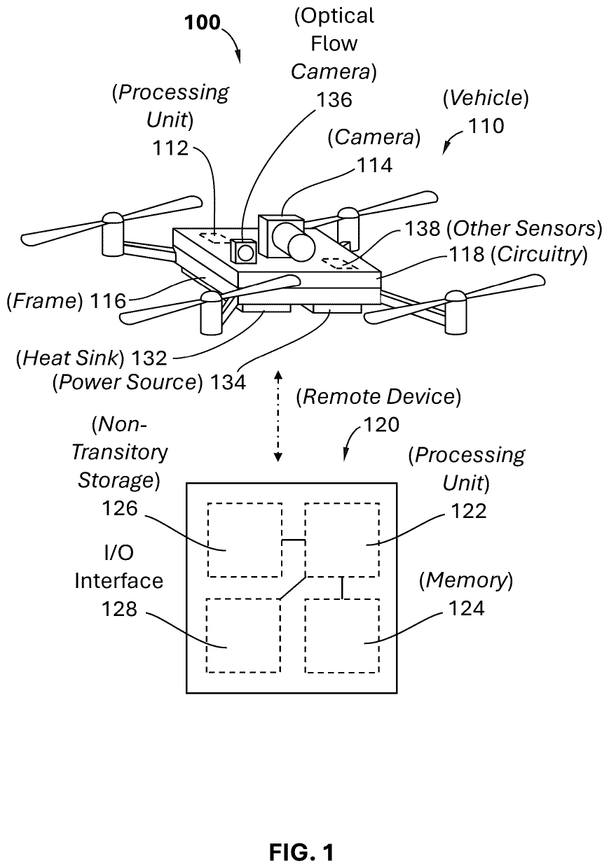

A system for navigation may be provided. Referring to FIG. 1, the system (100) may include one or more processing units (112, 122) configured to, collectively, perform various tasks.

As used herein, the term “processing unit” generally refers to a computational device capable of accepting data and performing mathematical and logical operations as instructed by program instructions. This may include any central processing unit (CPU), graphics processing unit (GPU), core, hardware thread, or other processing construct known or later developed. The term “thread” is used herein to refer to any software or processing unit or arrangement thereof that is configured to support the concurrent execution of multiple operations.

Some or all of the processing unit(s) may be disposed on a vehicle (110). The vehicle may be any appropriate vehicle. One preferred vehicle is a drone, such as a flying drone, which may be a micro aerial vehicle (MAV). However, those skilled in the art will recognize other vehicles besides a MAV may be utilized, such as passenger or commercial road vehicles (cars, trucks, vans, etc.), drones such as rolling or walking delivery drones, etc.

The vehicle may include a camera (114). In one preferred embodiment, the camera is a monocular camera. The camera may take undistorted images, but in some embodiments, the camera may take distorted images, depending on, e.g., the lens utilized. For example, a fisheye lens may generate some amount of barrel distortion, a convex spherical lens may generate pincushion distortion, etc. The vehicle may include a frame (116), and may include circuitry (118) coupled directly or indirectly to the frame. The circuitry (118) may include the one or more processing unit(s) (112), and may control the operation of the camera (114), as well as control motion of the vehicle (110).

The circuitry may be operably coupled to a heatsink (132) and/or a power source (134). The power source may include any known source for providing power to the circuits, e.g., batteries, fuel cells, capacitors, etc. The circuitry may be operably coupled to one or more other sensors (138), such as gyroscopes, accelerometers, etc. The circuitry may be operably coupled to an optical flow camera (136) (e.g., a camera designed to detect and measure the optical flow in a scene).

The system may include a remote device (120), that may include a processing unit (122). Like all processing unit(s) disclosure herein, the processing unit may be operable coupled to a memory (124), non-transitory computer-readable storage device (126), and/or an I/O interface (128).

As will be understood, in some embodiments, all substantive processing steps in the disclosed technique may be performed by a remote device (120). In other embodiments, it may be possible to perform all processing steps on the vehicle (110). In still other embodiments, some of the processing steps may be performed by a remote device (120). For example, the system may be configured to offload some of the resource-intensive steps, or some steps that do not need to be run frequently, to the remote device (1200, and leave the less resource-intensive steps, or some of the steps that need to be run continuously on the vehicle (110).

The system may be configured to perform a method. For example, one or more non-transitory computer readable storage device(s) may contain instructions that, when executed by the one or more processing unit(s), cause the processing unit(s) (and the system overall) to perform certain steps, those steps generally following a method as disclosed herein.

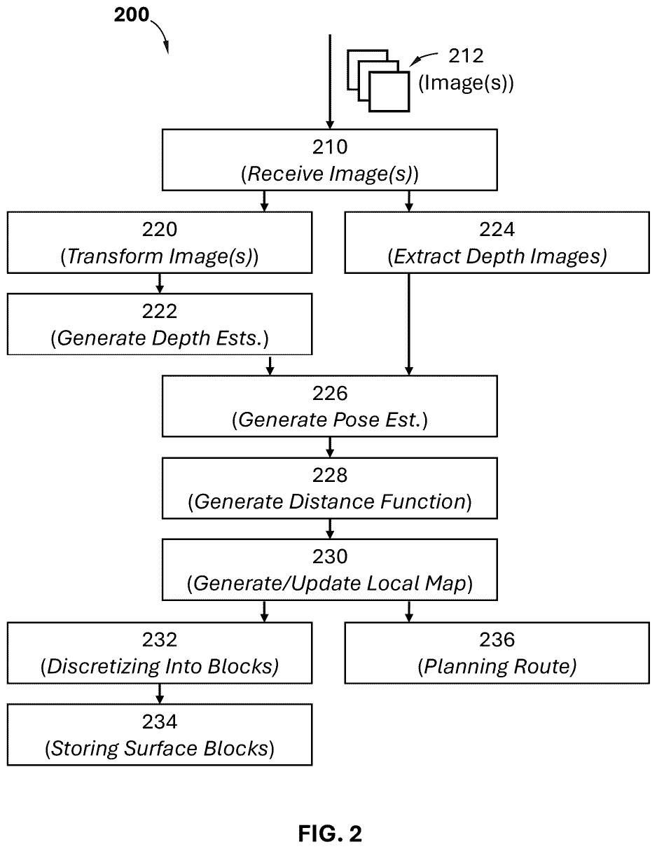

A flowchart of an embodiment of the method can be seen in FIG. 2. The method (200) may include receiving (210) one or more images (212) from a camera, and preferably a monocular camera. Any appropriate image may be received. For example, the images may be single still images, or may be, e.g., one or more frames from a video.

In some instances, the received image(s) may be undistorted images. In some instances, the received image(s) from the camera may include one or more distorted images. Thus, the method may include generating (220) transformed image(s) from the distorted image(s). This may include using any of the known technique for removing the distortion. The image distortion considered here may preferably include geometric image distortions (e.g., barrel distortion, pincushion distortion, keystone distortion, and/or perspective distortion). In some instances, the distortion considered here may include lens distortion (such as radial distortion, including barrel and/or pincushion distortion), and/or spherical aberrations. In some embodiments, chromatic aberrations or distortions are not considered. In some embodiments, compression distortion (e.g., loss of detail due to compression of the image) is not considered.

In some instances, the received image(s) may include a first distorted image, and the method may include extracting (222) multiple depth images from the first distorted image using a virtual camera rotation scheme.

To perform depth estimation with the pre-trained neural network, it is preferable that the input images match the camera intrinsics of the dataset the network was trained on. In other words, the input images should preferably appear to be taken with the same camera as the dataset images. This transformation is straightforward given the intrinsics and distortion coefficients for the source and target cameras.

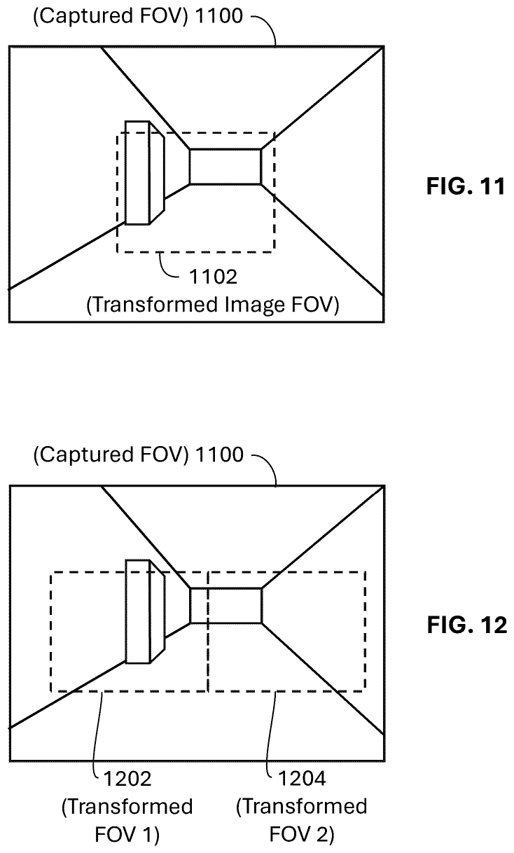

However, when the image is transformed from the drone camera intrinsics to the intrinsics required for depth estimation, much relevant peripheral information may be lost. A simple example of this is shown in FIG. 11, where scope of the originally captured field of view (1100) is shown, and where the dashed box shows the substantially more limited transformed image field of view (1102).

The insight with the virtual rotation is that the original captured image can be split into an arbitrary number of potentially overlapping sub-images with the correct intrinsics. In other words, one can capture more (or all) of the original field of view while also obeying the necessary image intrinsics by splitting the original image into multiple overlapping sub-images. The sub-images are also undistorted and obey the necessary intrinsics. A visualization of this is shown in FIG. 12, where the originally captured field of view (1100) is shown, along with a left (transformed FOV 1 (1202)) and right (transformed FOV 2 (1204)) sub-images. As will be understood, by appropriate selection of sub-images, some or all of the originally captured field of view (1100) may be captured in the transformed sub-images.

Considering FIGS. 11 and 12, in addition to the original “transformed” image (see transformed image field of view (1102)), one can also get, e.g., at least a left and a right image (transformed FOV 1 (1202) and transformed FOV 2 (1204)) that obey the intrinsic properties for depth estimation. One can readily get the depth estimates of all three (or more) images through batch-inference, using well-known techniques, and stitch them back together in the reconstruction.

As will be understood, one can split the original image into an arbitrary number of overlapping sub-images, in both the vertical and horizontal directions. In some embodiments, only horizontal rotations are considered (e.g., (i) left and right, or (ii) left, right, center, etc.) In one preferred embodiment, the virtual rotations include only a left, right, and center sub-images.

In one preferred embodiment, the virtual camera rotation scheme may use the following built-in functions of openCV:
map1, map2=cv2.initUndistortRectifyMap (calibrated_intrinsic_matrix, calibrated_distortion_coefficients, desired_rotation_matrix, target_intrinsic_matrix, (target_image_width, target_image_height), cv2.CV_32FC1)
rotated_image=cv2.remap (input_image, map1, map2, cv2.INTER_LINEAR)

In some embodiments, this may be repeated for three desired rotation matrices: 25 degrees to the right, no rotation (identity), and 25 degrees to the left. As will be understood, the specific degrees of rotation may vary as desired.

Thus, in some embodiments, for the purpose of depth estimation, this transformation may capture some or all of the entire periphery of the originally captured FOV.

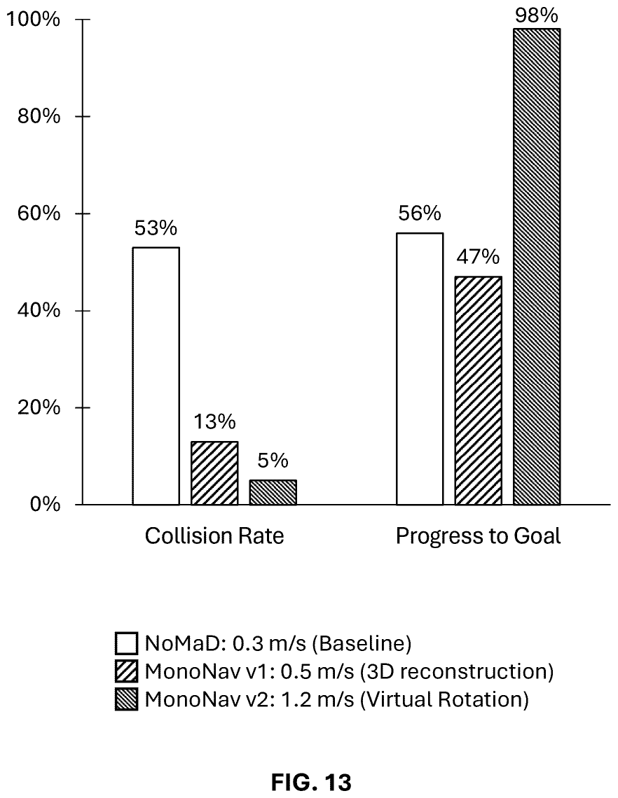

This virtual rotation may significantly improves performance, because it is able to extract more of the crucial peripheral information from each image. As such, it can rely on making decisions from each image, rather than relying on long multi-image reconstructions to gain a full understanding of the environment. This is shown in FIG. 13, where use of the virtual rotation substantially lowered the collision rate and greatly increased the progress to goal over a same stretch of hallways versus the baseline NoMaD performance and the MonoNav performance without the virtual rotation scheme.

The method may include generating (224) metric depth estimates for each pixel in the received image(s) or transformed image(s) based on the received image(s), using a pre-trained model configured to do so. In one preferred embodiment, the generating (220) of the transformed image(s) is configured such that transformed image(s) appear to have been taken with a same camera used to train the pre-trained model. For example, this may include adjusting an image size, resolution, color depth, etc.

The method may include generating (226) a pose estimate from visual odometry.

The method may include generating (228) a truncated signed distance function representation of an environment based on the absolute depth estimates and the pose estimate.

The method may include generating or updating (230) a local map (e.g., of the environment the vehicle is travelling through, being built as the vehicle moves) based on the truncated signed distance function representation.

The method may include discretizing (232) the environment into blocks. The method may include storing (234) blocks containing surfaces in a hashmap.

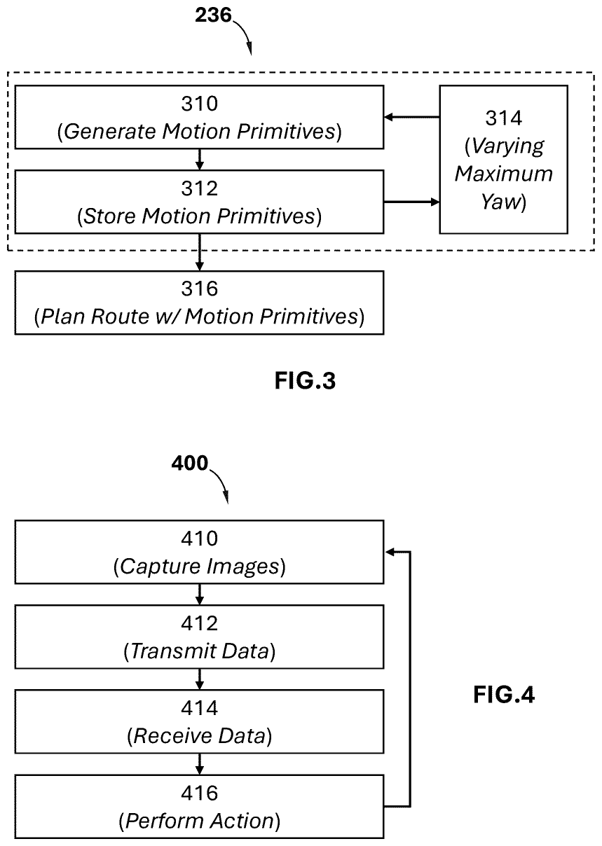

The method may include planning (236) a collision-free route towards a goal based on the local map. Planning (236) the collision-free route may include using motion primitives. Referring to FIG. 3, the method may include generating (310) motion primitives and storing (312) the motion primitives in a library (e.g., a trajectory library). The motion primitives may be defined to have a yaw rate that is zero at the beginning and end of each motion primitive. A library of motion primitives may be generated by repeatedly generating additional motion primitives after varying (314) a maximum yaw rate.

In some embodiments, the trajectory primitives may be converted into velocity commands by remote processing unit(s), and sent to the vehicle in an open-loop, real time fashion. That is, the remote processing unit(s) may send a command to the drone periodically, such as multiple times per second, such as every 0.05 s.

In other embodiments, asynchronous primitives may be stored and executed by the drone's low-level controller. For example, the vehicle may include, e.g., raw representation trajectory formats. In the Crazyflie raw representation, for example, each primitive may be represented as the coefficients of a 7th degree polynomial describing the desired x, y, z position as a function of time. Thus, in some embodiments, the motion primitives may be uploaded to the drone at runtime, and the remote processing unit(s) may then simply tell the drone to, e.g., “execute primitive n”, after which the vehicle would then execute that primitive with its onboard feedback position control asynchronously (e.g., with no further communication from the remote processing unit(s)). Such an approach may be cleaner, allowing for faster/more precise trajectory primitives, and may allow for more intense computations (such as computational increases required by virtual rotations). Using this alternate embodiment, the example MAV has been able to achieve more dynamic motion primitives and speeds of up to 1.7 m/s.

Planning the collision-free route may include utilizing any appropriate path-finding algorithm. For example, planning the route may include utilizing A*, Probabilistic Roadmaps (PRM), rapidly-exploring random tree (RRT), RRT*, or Trajectory Hybrid Optimal Frenet.

The steps for generating a library (e.g., within the dashed box in FIG. 3) may be performed by the vehicle, but may preferably be performed offline (e.g., by processing unit(s) on a remote device).

Referring to FIG. 4, in some embodiments, all of these steps are performed offline, with the vehicle only performing a very limited method (400), which may include capturing (410) image(s), and transmitting (420) data to a remote device. The transmitted data may include the captured image(s), in a compressed or uncompressed format. The transmitted data may include other information related to motion of the vehicle, such as speed, elevation, etc. After the remote device(s) perform their steps, and a motion primitive (or other action) has been selected, that action may be communicated back to the vehicle. Thus, the vehicle may also be configured to receive (414) data from a remote device (which may or may not be the same remote device the vehicle transmitted data to, although preferably it is the same remote device). The transmitted data may define an action for the vehicle to take. The vehicle may then perform (416) that action, which may include changing velocity, changing direction, moving in a particular direction, etc. This would then be repeated until either a goal is reached or the vehicle is required to stop for some reason (e.g., if it is determined to be impossible to reach the goal).

The method may include repeatedly performing at least the receiving (210), generating (226, 228), and updating (230) steps as a vehicle including the camera moves within the environment (e.g., at forwards velocities of at least 0.5 m/s). The vehicle may have almost any forward velocity, but in some embodiments, the vehicle may have a maximum forward velocity of 0.01 m/s, 0.1 m/s, 0.5 m/s, 0.75 m/s, 1 m/s, 1.25 m/s, or 1.5 m/s up to 1.5 m/s, 2 m/s, 2.5 m/s, 3 m/s, 4 m/s, or 5 m/s, or any combination or subrange thereof.

### EXAMPLE

The smallest class of unmanned aerial vehicles (UAVs), referred to as micro aerial vehicles (or MAVs, ≤100 g), are well-suited for constrained indoor applications such as inspection, exploration, and mapping. However, their small size and weight restricts their ability to carry sensors that provide high-resolution metric depth information (e.g., LiDAR or stereo cameras). While there have been advances in sensor and computer miniaturization towards fully onboard systems, such as a 2.28 g Time of Flight depth sensor or 4.4 g GAP8 embedded processor, the low sensor resolution and limited compute result in low levels of autonomy (e.g., object avoidance within highly structured settings).

Instead, the disclosed system assumes fully onboard sensing, but offboard computation—either in the form of a nearby desktop, trailing ground vehicle, or cloud. It is assumed in this example that a disclosed MAV has access to the typical instrumentation: a forward-facing monocular camera, an inertial measurement unit (IMU) for orientation and acceleration, and an optical flow camera and height sensor for position and velocity estimation.

For such a setup, the prevailing approach to monocular, vision-based exploration is to train an end-to-end model which takes as input a color image and outputs a velocity setpoint or trajectory of waypoints. In various conventional techniques, a learned mapper model infers spatial relationships from an RGB image to construct a 2D overhead view for SLAM. This approach performs well in simulated environments, but lacks validation in the real world. In other known techniques, a deep convolutional neural network trained entirely in simulation navigates a MAV through hallways in the real world. Such approaches, however, are typically overfit to the robots and environments seen in training.

To enable monocular navigation performance across diverse real-world environments, one previously disclosed approach proposes a general-purpose, goal-image-based policy trained and deployed across a wide range of environments and robot embodiments. In addition to requiring sub-goal images, such policies require a topological graph of the environment, which must be demonstrated (through teleoperation) or generated through cautious robot exploration. To overcome this and enable efficient exploration, a known approach called ViNT proposes sub-goal generation through image diffusion; the sub-goal images are spatially grounded and scored by a heuristic (e.g., goal position). More recently, a known approach called NoMaD trains a diffusion policy, which takes a series of images and outputs normalized action candidates. These action candidates are un-normalized into position trajectories using a robot-specific range. In a variety of environments, NoMaD outperforms ViNT by 25% in terms of both efficiency and collision avoidance, making it the state-of-the-art approach to monocular navigation.

While NoMaD is able to learn and demonstrate impressive navigation and exploration behaviors across diverse settings, the primary limitation is that the system does not reason explicitly about the environment scale. The action candidates from NoMaD's diffusion policy are not metric; while a scaling factor can be tuned for a specific robot/camera pair, the policy is not guaranteed to produce spatially sensible actions. This can lead to collisions on robots and in environments outside of the training distribution. It should be noted that all of the aforementioned methods are too computationally heavy to run onboard a 37 g MAV and thus require offboard computation.

In this example, the following question is asked—using only a monocular camera for sensing obstacles, can one obtain depth maps with sufficient metric accuracy to enable 3D reconstruction of the MAV's environment? This would enable use of motion planning and navigation techniques used by larger state-of-the-art UAVs.

It is hypothesized that a modular pipeline consisting of depth estimation, local mapping via fusion, and planning will enable significantly faster flight and more robust generalization to unseen environments. In addition, this modular approach allows one to directly leverage improvements in depth estimation and motion planning without having to retrain an end-to-end policy from scratch.

Finally, such an approach affords the ability to easily incorporate new objectives into the navigation stack (e.g., tracking a target object or constraining the drone's camera angle for cinematic applications).

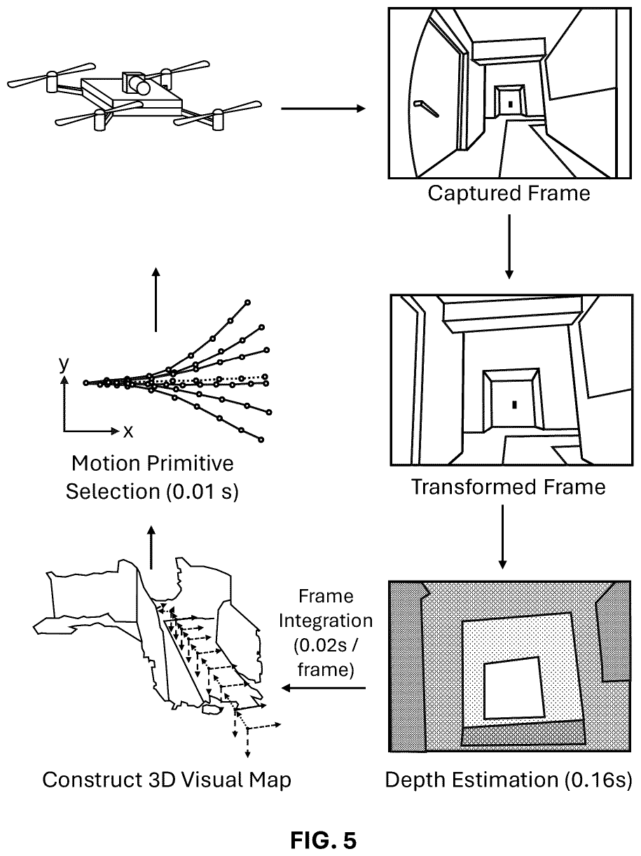

The example approach was termed “MonoNav”. MonoNav is composed of simultaneous reconstruction and planning processes (see FIG. 5). Due to the limited compute onboard a MAV, MonoNav (and all state-of-the-art approaches) require offboard compute.

The monocular mapping process is broken into two stages: metric depth estimation and fusion. Recent advances in monocular depth estimation were leveraged that produce metric depth estimates from a single image. One of the key requirements of the disclosed navigation stack to demonstrate generalization is to use only pre-trained models for depth estimation without any fine-tuning. Due to the domain shift that arises from the difference between the MAV's fish-eye camera and the camera used for training the depth estimation models, a lightweight image pre-processing step (FIG. 5, middle right) was used that transforms a source image from the MAV's camera to a target image that appears as though it was taken with the camera used to train the pre-trained models. This can be achieved with a standard image processing library since both cameras' intrinsics are known. The transformed image was then passed to a pre-trained model which performs monocular depth estimation.

In contrast to prior techniques that only produce depth images up to an unknown scaling factor, recent approaches produce absolute estimates of depth for every pixel. MonoNav uses ZoeDepth (specifically, ZoeD N) for per-frame metric depth estimation (see FIG. 5, bottom right).

Combined with the drone's pose estimates from optical flow odometry, MonoNav uses off-the-shelf depth fusion to create a Truncated Signed Distance Function (TSDF) representation of the environment. The 3D map is represented using Open3D's VoxelBlockGrid representation, which discretizes the world into voxels (each with a TSDF value and weight). TSDF fusion is performed on each collected depth image to construct a local map. See FIG. 5, bottom left. This fusion process corrects for per-frame errors in depth estimation and also provides a memory of previously seen portions of the environment.

At each time step, the robot has access to the map in the form of a VoxelBlockGrid. For collision-free navigation towards a goal, motion primitives are used; as will be understood, however, other planning approaches (e.g., A*, RRT*) could also be utilized.

The motion primitives and open-loop velocity setpoints are generated in a single offline step and stored in a trajectory library. From a desired constant speed V, maximum yaw rate A, and horizon T, one can define the motion primitives from a Dubins' car dynamics model, with forward velocity \dot{x}ₛₚ(t)=V and yaw rate

$${\dot{ψ}}_{sp} ( t ) = A sin ( \frac{π t}{T} ) .$$

This ensures that yaw rates are zero at the beginning and end of each primitive for smooth transitions between primitives. One can integrate the inputs to determine the spatial trajectory used in primitive selection. By varying A, a library of primitives is generated.

At runtime, the vehicle considers the set [symbol] of available trajectories τ∈ [symbol] ^{n×3}, each consisting of n position waypoints. One can also define the set [symbol] ₒ of occupied voxel coordinates vₒ∈ [symbol] ³, in the VoxelBlockGrid, as well as the minimum distance D(τ, x) from any point along the trajectory τ to a coordinate x∈ [symbol] ³:

$$D ( τ , x ) = {min}_{0 \leq i < n} {‖ {τ}_{i} - x ‖}_{2} . \qquad ( 1 )$$

At each navigation step, the motion primitive τ* that brings the vehicle closest to the goal position x_{g}∈ [symbol] ³ while maintaining a tunable minimal distance c∈ [symbol] _{>0} from any obstacle is selected:

$${τ}^{*} = arg {min}_{τ ∈ 𝒯} D ( τ , {x}_{g} ) subject to D ( τ , {v}_{o} ) \geq c , ∀ {v}_{o} ∈ {𝒱}_{o} . \qquad ( 2 )$$

In practice, one can determine the set [symbol] ₒ by filtering all voxels in the VoxelBlockGrid by thresholds for weight and TSDF value. One can exhaustively compute the distances from all trajectory points to the goal position and to every occupied voxel. Here, if no motion primitive satisfies the distance threshold criterion (i.e., Eq. 2 is infeasible), the MAV is instructed to stop and land. The parameter c can be decreased to increase feasibility, though the MAV may fly closer to obstacles. In this way, c can be used to tune how conservatively MonoNav behaves. This self-arresting capability distinguishes MonoNav from state-of-the-art approaches like NoMaD, whose termination conditions are “reach goal” or “crash”.

### Hardware Evaluations.

MonoNav was implemented on the Crazyflie 2.1, a MAV configured as in Kang, K., et al., “Generalization through simulation: Integrating simulated and real data into deep reinforcement learning for vision-based autonomous flight”, 2019 international conference on robotics and automation (ICRA), pp. 6008-6014. IEEE (2019).

The Crazyflie is outfitted with a Flow deck v2 for position and velocity estimation and a Wolfwhoop WT05 RGB camera. Our offboard computer, which has a Geforce RTX 4090 GPU, communicates with the MAV and receives the analog video stream over radio. The Wolfwhoop camera suffers from significant ‘barrel distortion’ due to its fish-eye lens; this image was transform to the desired camera intrinsics using OpenCV's undistortion and warp affine functions.

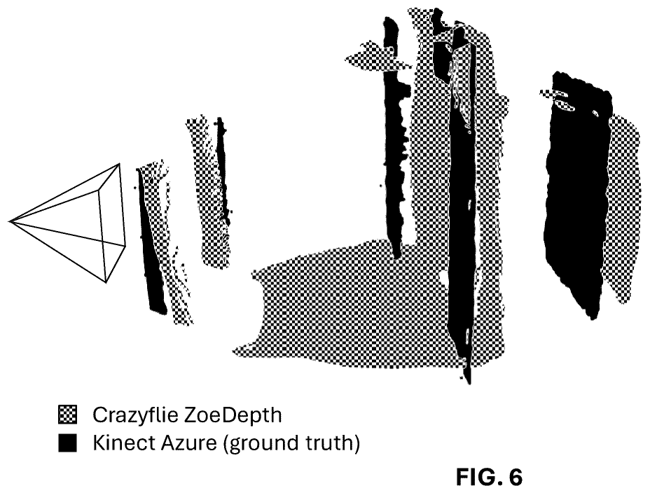

For per-frame depth estimation evaluation, the Crazyflie's Wolfwhoop and Microsoft Kinect (ground truth) cameras were rigidly connected, and they were maneuvered along typical trajectories in indoor hallway scenes. The typical approach of pixel-wise comparison was followed; to address the differing camera intrinsics, the points were re-projected to match as closely as possible. It is important to note that despite calibration, undistortion, and finding homographies to align features, the pixels did not match perfectly (see FIG. 6), which increases the pixel-wise error.

The evaluation from Bhat, S. F., et al., “ZoeDepth: Zero-shot transfer by combining relative and metric depth. arXiv preprint arXiv:2302.12288 (2023) was followed, and it was determined that the absolute relative error

$$( REL ) = \frac{1}{M} {\sum }_{i = 1}^{M} \frac{\vert {d}_{i} - {\hat{d}}_{i} \vert}{{d}_{i}} ,$$

the root mean squared error

$$( RMSE ) = {[ \frac{1}{M} {\sum }_{i = 1}^{M} {\vert {d}_{i} - {\hat{d}}_{i} \vert}^{2} ]}^{\frac{1}{2}} , the average {log}_{10} error = \frac{1}{M} {\sum }_{i = 1}^{M} \vert {log}_{10} {d}_{i} - {log}_{10} {\hat{d}}_{i} \vert ,$$

and the threshold accuracy δₙ=% of pixels s.t.

$$max ( \frac{{d}_{i}}{{\hat{d}}_{i}} , \frac{{\hat{d}}_{i}}{{d}_{i}} ) < {1.25}^{n} for n = 1 , 2 , 3$$

(i.e., the fraction of pixels within a scale factor of 1.25ⁿ). The quantities dᵢ and \hat{d}ᵢ refer respectively to the ground truth and predicted depth at pixel i, and M is the total number of pixels in the image. In addition, to address any pixel-wise overestimation of error, one can also determine the point-cloud distance

$$( PCD ) = \frac{1}{\vert G \vert} {\sum }_{g ∈ G} {min}_{e ∈ E} {‖ g - e ‖}_{2} ; i . e . ,$$

for each point g in the ground-truth point-cloud G, its distance to the closest point in the estimated point-cloud E is calculated. See FIG. 6, and Table 1 for the quantitative results.

Table 1. ZoeDepth depth estimation evaluation in the MonoNav pipeline (i.e., on a MAV camera in hallway environments). Units: meters. Arrows indicate the direction of better performance. PCD is bolded as the fairest metric.

| Method | δ₁ ↑ | δ₂ ↑ | δ₃ ↑ | REL ↓ | RSME ↓ | log₁₀ ↓ | PCD ↓ |
|---|---|---|---|---|---|---|---|
| MonoNav | 0.62 | 0.85 | 0.95 | 0.48 | 1.05 | 0.11 | 0.41 |

ZoeDepth's performance in the MonoNav pipeline against Kinect Azure ground truth depth is shown in Table 1. The errors are averaged over 77 frames from a typical navigation sequence. Due to pixel mismatch between the different cameras, point cloud distance (PCD) is bolded as the fairest metric. With RMS Error of 1.05 m, and PCD error of 0.41 m, ZoeDepth is able to provide a sufficiently accurate metric depth for indoor reconstruction and navigation.

For hardware experiments, one can define a set of motion primitives (FIG. 4, bottom left) by

$$T = 1. s , V = 0.5 m / s and A ∈ {\{ - 0.7 + k 0.2 \overline{3} \}}_{k = 0}^{6} rad / s .$$

The distance threshold c=0.5 m and the goal position x_{g}=(10, 5, 0.4) m (in an East-North-Up world frame) was set. The camera has a measured lag of 0.12 s, per-frame depth estimation with ZoeDepth takes 0.11-0.16 s, fusion takes 0.02 s, and motion primitive selection takes 0.01 s. Camera readings, depth estimation, and integration occur at 3-4 Hz and replanning occurs at 1 Hz. It should be noted that both fusion and planning take longer as more voxels are added to the map. MonoNav was tested in constrained hallway settings. These settings vary in complexity, ranging from straight sections, T-intersections, curved walls, and open spaces with columns. In 15 runs across 10 unique indoor settings MonoNav navigates successfully and avoids most obstacles. Of the 15 runs, MonoNav crashed once, and was prematurely terminated once. In both cases, MonoNav turned into a wall or dead-end that was previously occluded and thus not perceived as an obstacle.

The goal position x_{g}=(10, 5, 0.4) m induced a leftward bias into the navigation, which is reflected in the trajectories.

### Comparison to State of the Art: NoMaD.

To evaluate MonoNav against state of the art monocular navigation techniques, it was compared to NoMaD: Goal Masked Diffusion Policies for Unified Navigation and Exploration. See Sridhar, A., et al., “NoMaD: Goal masked diffusion policies for navigation and exploration”, arXiv preprint arXiv:2310.07896 (2023). NoMaD uses EfficientNet encoders and a Transformer decoder to transform a series of recent observations and (optional) goal image into a “context.” NoMaD uses the context to condition action diffusion, producing normalized action candidates, which are scaled based on the robot's physical characteristics. The goal masking ensures NoMaD can operate in goal-image-directed (“navigation”) and goal-image-agnostic (“exploration”) modes. For the purposes of this evaluation, NoMaD was only run in exploration mode to match MonoNav.

NoMaD and MonoNav were evaluated side-by-side in 5 unique environments. Each environment has a goal position, which encourages a certain behavior (e.g., straight, left turn, right turn). Three trials were run for each method in each environment (30 runs total). Performance was calculated both in terms of goal completion (%) and collision rate, and report values in Table 2. Goal completion (% to Goal) is calculated as 1−∥x_{T}−x_{g}∥/∥x₀−x_{g}∥, where x₀, x_{T}, x_{g} are the initial, final, and goal positions. Collision rate is the ratio of collisions to runs.

Since all of the action candidates suggested by NoMaD should in principle be collision-free (and there is no other way to reason about proximity to obstacles), the action candidate which makes the most progress towards the goal was chosen. Additionally, other than reaching the goal or manual termination, there are no other criteria for self-stopping in NoMaD as there are in MonoNav.

For the evaluation, MonoNav has access to 11 one-second motion primitives at V=0.5 m/s, with \dot{ψ} amplitudes defined by

$$A ∈ {\{ - 0.7 + k 0.14 \}}_{k = 0}^{10} rad / s .$$

The distance threshold c was set to 0.2 m. MonoNav flies each motion primitive open-loop through velocity control, resulting in smooth, chained primitives. NoMaD accepts a series of images directly from the Wolfwhoop camera. The settings were kept identical to the original paper wherever possible, and NoMaD was configured to output 8 action candidates. These action candidates are not exactly metric; through testing, a factor of 1/7 was determined to be an appropriate, conservative approach for indoor hallways. Following the paper, the first 3 waypoints were followed in open-loop fashion before re-planning.

### Results: Baseline Comparison.

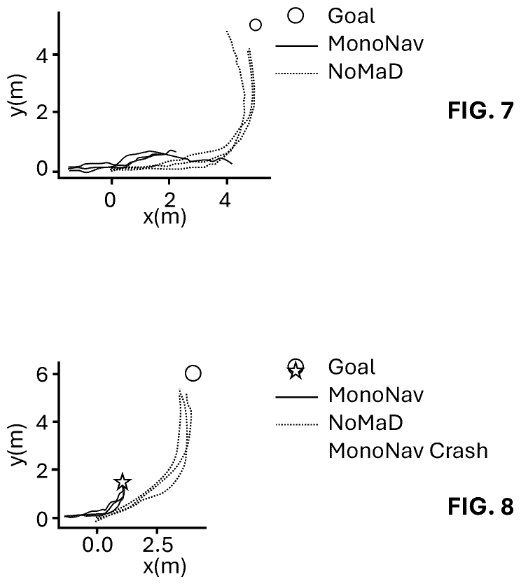

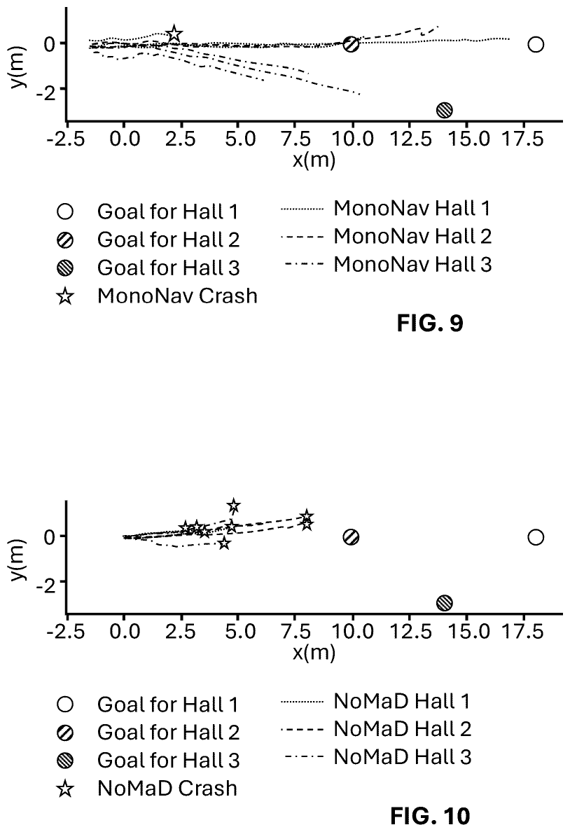

The performance of MonoNav and NoMaD, averaged over 15 trials (each) in 5 diverse settings, is shown in Table 2 and FIGS. 7-10. As shown in the FIGS. 7-10, MonoNav outperforms NoMaD during straighter segments (see FIGS. 9-10); NoMaD outperforms MonoNav in cornering, when a clear, agile maneuver is required (see FIGS. 7-8). Note while the walls are not depicted, the hallway width is typically 2.5 meters throughout. Due to its reliance on past frames for reconstruction, MonoNav was “warm-started” at x₀=(−1.5,0.0). It was found that while MonoNav has a 22% decrease in goal-seeking performance, it has a 4× improvement in collision avoidance. This is because MonoNav can use the 3D reconstruction to reason about collisions, and stop itself if no primitive remains sufficiently far from obstacles. Noise in the state and depth estimates translates to noise in the point cloud, so MonoNav is typically over-conservative, resulting in the 22% degradation in performance.

Table 2. Average monocular navigation performance in 15 trials (each) across 5 environments. % to Goal is the ratio of progress to the goal, and collision rate is the ratio of collisions. The top performer in each column is bolded.

| Method | % to Goal ↑ | Collision Rate ↓ |
|---|---|---|
| MonoNav | 47.4% | 0.13 |
| NoMaD | 61.0% | 0.53 |

The main disadvantage to NoMaD is the lack of concrete spatial grounding. While NoMaD regularly produces meaningful action candidates, it is also prone to over- or under-reacting, such as a U-turn in a tight space. Furthermore, since information is not preserved over longer horizons (as in MonoNav), NoMaD can be tricked (e.g., by a featureless wall or poster). In our experiments, it was found that NoMaD does very well in cornering, when there is clear consensus among action candidates, but (surprisingly) poorly in straights, where the action candidates under-react and NoMaD tends to drift into walls. In these cases, NoMaD is limited by its inability to self-terminate when collision is imminent. Finally, the nature of NoMaD's diffusion policy makes the actions stochastic and unrepeatable, making behaviors difficult to explain and reproduce.

What is claimed is:

1. A system for navigation, comprising:
one or more processing units configured to, collectively:
receive one or more images from a monocular camera;
generate metric depth estimates for each pixel in the one or more images or one or more transformed images based on the one or more image, using a pre-trained model;
generate a pose estimate from visual odometry;
generate a truncated signed distance function representation of an environment based on the absolute depth estimates and the pose estimate; and
update a local map based on the truncated signed distance function representation.

2. The system of claim 1, wherein the one or more processing units are further configured to, collectively, generate the one or more transformed images such that the one or more transformed images appear to have been taken with a same camera used to train the pre-trained model.

3. The system of claim 1, wherein the one or more processing units are further configured to, collectively, discretize the environment into blocks, and store blocks containing surfaces in a hashmap.

4. The system of claim 1, wherein the one or more processing units are further configured to, collectively, plan a collision-free route towards a goal based on the local map.

5. The system of claim 4, wherein planning the collision-free route includes using motion primitives.

6. The system of claim 5, wherein the motion primitives are generated in a single offline step and stored in a trajectory library.

7. The system of claim 6, wherein the motion primitives are defined to have a yaw rate that is zero at the beginning and end of each motion primitive.

8. The system of claim 7, wherein a library of motion primitives are generated by varying a maximum yaw rate.

9. The system of claim 4, wherein planning the collision-free route includes utilizing A*, Probabilistic Roadmaps (PRM), rapidly-exploring random tree (RRT), RRT*, or Trajectory Hybrid Optimal Frenet.

10. The system of claim 1, wherein the one or more processing units are disposed on a vehicle.

11. The system of claim 1, wherein the one or more images received from the monocular camera include a first distorted image, and the one or more processing units are further configured to, collectively, extract multiple depth images from the first distorted image using a virtual camera rotation scheme.

12. A drone comprising the system of claim 1.

13. The drone of claim 12, wherein the drone is a micro aerial vehicle (MAV).

14. The drone of claim 12, wherein the drone is a drone other than a micro aerial vehicle (MAV).

15. A method for navigation, comprising:
receiving one or more images from a monocular camera;
generating metric depth estimates for each pixel in the one or more images or one or more transformed images based on the one or more images, using a pre-trained model;
generating a pose estimate from visual odometry;
generating a truncated signed distance function representation of an environment based on the absolute depth estimates and the pose estimate; and
updating a local map based on the truncated signed distance function representation.

16. The method of claim 15, further comprising repeatedly performing the receiving, generating and updating steps as a vehicle including the monocular camera moves within the environment.

17. The method of claim 16, wherein the vehicle is moving at least 0.5 m/s through the environment.
